(19) United States
(12) Patent Application Publication
(10) Pub. No.: US 2010/0324999 A1
(43) Pub. Date: Dec. 23, 2010

(54) ADVERTISEMENT PROXY SERVICE

(75) Inventors: Matthew Conway, Weymouth, MA (US); George Grey, Wayland, MA (US); Jason Haruska, Belmont, MA (US)

Correspondence Address: MILLER, MATTHIAS & HULL, ONE NORTH FRANKLIN STREET, SUITE 2350, CHICAGO, IL, 60606, US

(73) Assignee: Mobicious, Inc., Needham, MA (US)

(21) Appl. No.: 12/820,871

(22) Filed: Jun. 22, 2010

Related U.S. Application Data
(60) Provisional application No. 61/219,299, filed on Jun. 22, 2009.

(51) Int. Cl. G06Q 30/00; G06F 3/14

(52) U.S. Cl. 705/14.73; 715/760

(57) ABSTRACT

An advertising proxy server enables limited-functionality web browsers, such as those commonly installed on mobile devices, to display web page content quickly, without incurring the delay normally associated with displaying web pages containing advertisements. When such a web browser requests a web page containing advertisements from a web server, the web server: (1) serves the main web page content to the web browser; and (2) instructs the advertising proxy server to retrieve the web page's advertising content. The web browser may render the main web page content while the advertising proxy server is retrieving the advertising content from a conventional advertising server. The web browser requests the advertising content from the advertising proxy server, which serves the advertising content, when available, to the web browser, which then renders the advertising content. The web browser may perform these functions without the need to execute JavaScript or other non-HTML code.

### CROSS-REFERENCE TO RELATED APPLICATION

This application is a non-provisional application claiming the priority benefit under 35 U.S.C. 119(e) of U.S. provisional application No. 61/219,299, filed on Jun. 22, 2009.

### FIELD OF THE DISCLOSURE

The present disclosure generally relates to web browsing, and more particularly, to implementing an advertisement proxy service for web browsing applications.

### BACKGROUND OF THE DISCLOSURE

Online advertising has become the dominant source of online revenue for many businesses. Many online advertisements displayed within web pages are provided not by the web server that hosts the web pages themselves, but by third-party advertising servers. For example, when a user of a desktop computer, mobile phone, or other Internet-enabled device uses a web browser to visit a web page containing advertisements, the web page's web server may transmit to the user's web browser both: (1) the main content of the web page, such as a news article; and (2) code, such as code written in the JavaScript scripting language, for requesting one or more advertisements from a third-party advertising server. The web browser may then execute this advertisement code to request advertising content from the third-party advertising server. In response, the third-party advertising server transmits one or more advertisements back to the web browser. As a result, the web browser displays both the main web page content and the advertisements within the web page.

The need for the web browser to transmit two content requests—one to the web server and one to the advertising server—has the potential to introduce delay into the process of displaying the web page to the user. It is possible, however, for the web browser to avoid delay in displaying the main web page content to the user by rendering that content as soon as it is received by the web browser. The web browser may not even execute the code which requests advertising content until after the web browser has completed rendering the main web page content. The web browser may then render the advertising content within the web page after the advertising content is received. This scheme benefits both the user, who can begin viewing the main web page content as soon as possible after it is received by the web browser, and the provider of the web page content, who can be assured that rendering of the main web page content is not delayed by the time required to request and receive the advertising content. This scheme is illustrated in FIG. 1(a).

Such a scheme, however, often cannot be implemented by the web browsers installed on mobile devices, such as cellular telephones and personal digital assistants (PDAs), because such browsers often do not have the ability to execute JavaScript or other code for requesting advertising content. As a result, web sites that are designed for viewing on mobile devices are often designed so that a request from a mobile web browser to view a particular web page causes the web server itself to request advertising content from the third-party advertising server. The web server waits to receive the advertising content back from the advertising server before transmitting both the main web page content and the advertising content back to the web browser. Although this scheme has the benefit of enabling resource-constrained mobile devices to render advertising content within web pages without needing to execute JavaScript or other code, it has the significant disadvantage of making the web page response time (the time required for the web server to serve the requested web page to the web browser) dependent on the response time of the third-party advertising server. As a result, any slowdown in the response time of the third-party advertising server will delay the rendering not only of the advertising content but of the main web page content by the web browser. This effect is compounded if the web server must make multiple requests to the advertising server. This scheme is illustrated in FIG. 1(b).

It is therefore an object of the present disclosure to provide an improved technique for serving advertising content in web pages.

### SUMMARY OF THE DISCLOSURE

An advertising proxy server enables limited-functionality web browsers, such as those commonly installed on mobile devices, to display web page content quickly, without incurring the delay normally associated with displaying web pages containing advertisements. When such a web browser requests a web page containing advertisements from a web server, the web server: (1) serves the main web page content to the web browser; and (2) instructs the advertising proxy server to retrieve the web page's advertising content. The web browser may render the main web page content while the advertising proxy server is retrieving the advertising content from a conventional advertising server. The web browser requests the advertising content from the advertising proxy server, which serves the advertising content, when available, to the web browser, which then renders the advertising content.

In accordance with one aspect of the disclosure, a method for implementing an advertisement proxy service is provided. The method includes inserting a placeholder into a web page served to a web browser at a web content server; rendering content from the web page, and requesting advertising content from an advertising proxy server using the placeholder at the web browser; and requesting the advertising content from an advertising server, receiving the advertising content from the advertising server, caching the advertising content at the advertising proxy server, and serving the advertising content to the web browser at the advertising proxy server.

In accordance with another aspect of the disclosure, a computing apparatus is provided. The computing apparatus includes a display, an input device configured to receive user input, and a controller operatively coupled to the display and the input device. The controller is configured to operate a web browser on the display in accordance with user input from the input device. The controller configures the web browser to render content from a web page being served by a web content server having main web content and a placeholder for advertising content in the form of a request to the advertising proxy server, generate a first request for advertising content from an advertising proxy server based on the placeholder, and receive the advertising content.

In accordance with yet another aspect of the disclosure, another method for implementing an advertisement proxy service is provided. The method includes inserting an HTML image tag into a web page served to a web browser at a web content server; rendering content from the web page, and requesting advertising content from an advertising proxy server using the HTML image tag at the web browser; requesting the advertising content from an advertising server at the advertising proxy server, receiving the advertising content from the advertising server, and serving the advertising content to the web browser; and rendering the advertising content within the web page at the web browser.

These and other aspects of this disclosure will become more readily apparent upon reading the following detailed description when taken in conjunction with the accompanying drawings.

### BRIEF DESCRIPTION OF THE DRAWINGS

FIG. 1(a) is a timing diagram of interactions between a conventional desktop web browser, a conventional web server, and a conventional advertising server;

FIG. 1(b) is a timing diagram of interactions between a conventional mobile device web browser, a conventional web server, and a conventional advertising server;

FIG. 1(c) is a timing diagram of interactions between a mobile device web browser, web server, advertising server, and advertising proxy server according to an embodiment of the present invention; and

FIG. 2 is a data flow diagram of a system for serving web content and advertisements according to an embodiment of the present invention.

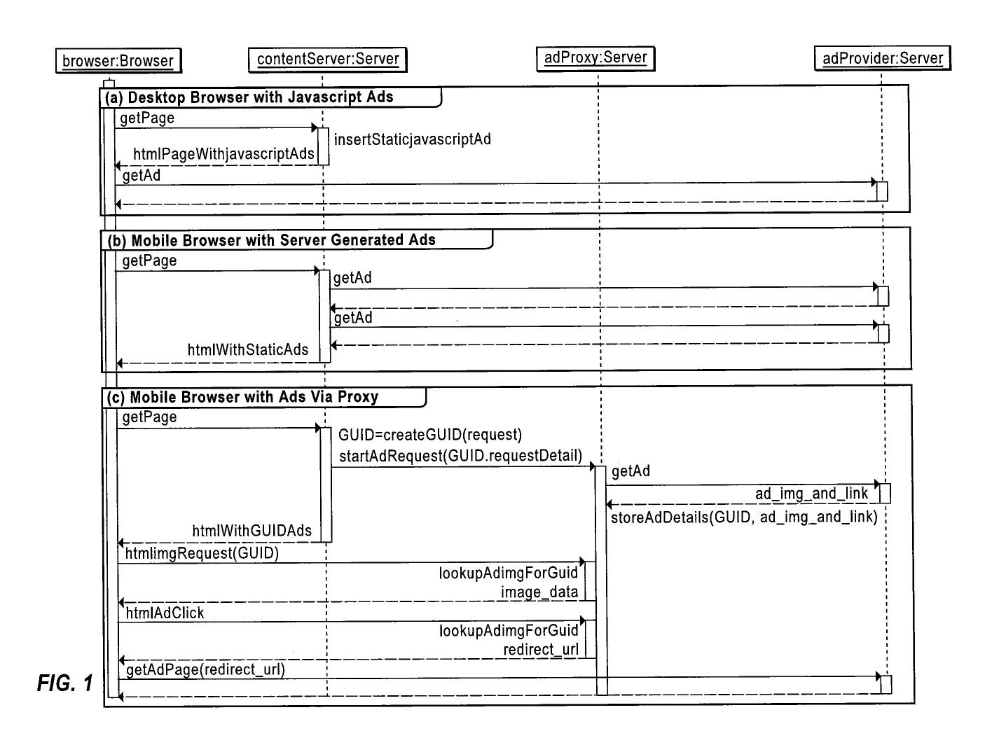

### DETAILED DESCRIPTION

Embodiments of the present invention enable a web browser, such as a web browser on a mobile device, which lacks the ability to execute JavaScript code (or other code for requesting advertising content) to receive and render the content of a web page before receiving (and possibly before requesting) advertising content for the same web page. As a result, the web browser may display the main web page content as soon as it is available from the web server, independent of the response time of the advertising server. As a result, the user's experience of viewing the main web page content is not negatively affected by any delay in the response time of the advertising server. The web browser, rather than the web server, may request the advertising content from the advertising server and then render the advertising content whenever it is received from the advertising server.

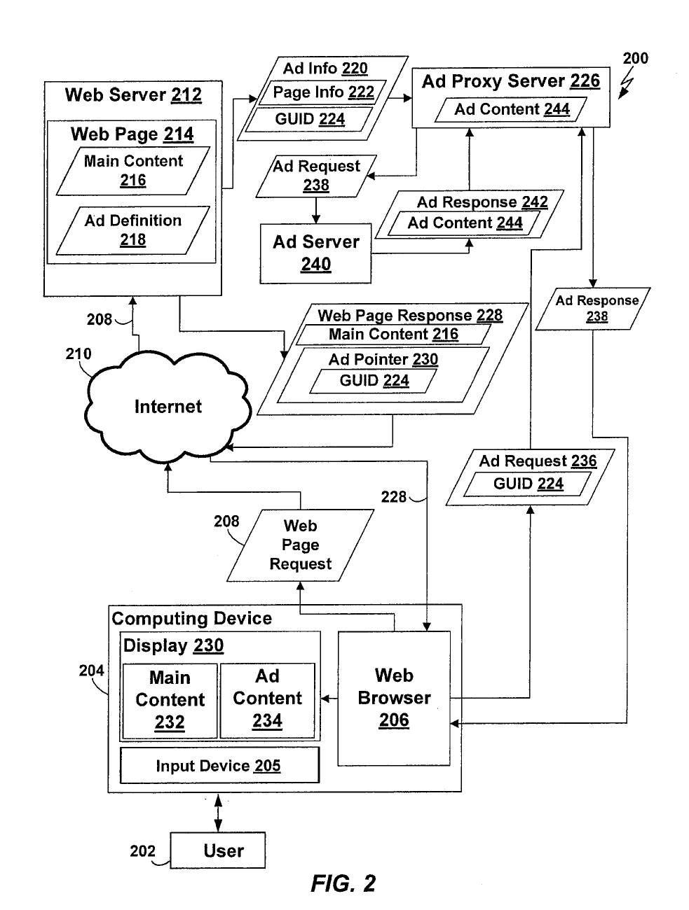

For example, referring to FIG. 2, a dataflow diagram is shown of a system 200 according to one embodiment of the present invention. In the system 200, a user 202 uses a computing device 204 (such as a cellular telephone, PDA, or other mobile computing device having limited computing resources) to browse the World Wide Web via an input device 205. The computing device 204 is equipped with a web browser 206, which may be a limited-capability web browser which lacks the ability to execute JavaScript code or other code for requesting advertising content from conventional advertising servers.

When the user 202 uses the web browser 206 to browse to a particular web page (such as by typing the URL of the web page into the address bar of the web browser 206, or by clicking on a hyperlink to the web page), the web browser 206 sends a web page request 208 for the web page over the Internet 210 (or other network) to a web server 212 which hosts the requested web page 214. Note that although only the single web page 214 is shown in FIG. 2 for ease of illustration, the web server 212 may host many web pages within a single web site, or even web pages within multiple web sites.

As shown in FIG. 2, the web page 214 may include both main content 216 and an advertisement definition 218. The main content 216 may be any kind of content, such as content representing a news article, product listing, map, or any other content that may be contained within a web page and served by the web server 212. The advertisement definition 218 includes information that defines advertising content that may be inserted into the web page 214 when the web page 214 is rendered by the web browser 206. The advertisement definition 218 need not contain the content (e.g., text and/or graphics) of the advertisement, but rather may specify features of an advertisement to be rendered within the web page 214. Typically such advertising content is not hosted by the web server 212, but rather by a third-party advertising server from which the advertising content must be retrieved before the advertising content may be rendered by the web browser 206.

As is well-known to those having ordinary skill in the art, the main content 216 and advertising definition 218 may take any of a variety of forms within the web page 214. The present invention is not limited to any particular one of these forms. Rather, the techniques disclosed herein may be applied to web pages in which the main content 216 and the advertising definition 218 are represented in any of a variety of ways.

In response to receiving the web page request 208, the web server 212 may create and transmit an advertising information message 220 to an advertising proxy server 226. In general, the purpose of the advertising proxy server 226 is to serve advertisements to the web browser 206 (and to other web browsers, not shown) on behalf of one or more individual advertising servers. The operation of the advertising proxy server 226 will be described in more detail below.

In general, the advertising information message 220 contains information 222 describing: (1) the web page 214 requested by the web browser 206 in the web page request 208; and (2) a globally unique identifier (GUID), generated by the web server 212, which identifies the web page request 208 in a way that distinguishes it from all other web page requests.

The web page information 222 may include, but is not limited to, the information needed by advertising providers to serve relevant ads. Such information 222 may take any of a variety of forms. For example, the web page information 222 may include the uniform resource locator (URL) of the requested web page and the time of the request 208. The GUID 224 may take any of a variety of forms, such as a hash value derived from the web page information 222 combined with a unique timestamp. These are merely examples and do not constitute limitations of the present invention.

In response to receiving the web page request 208, the web server 212 may also transmit a web page response 228 to the web browser 206. (Note that although the response 228 is shown as being transmitted directly from the web server 212 to the web browser 206 for ease of illustration, such a response, and other messages shown in the drawings, may in fact be transmitted through the Internet 210 and/or other networks.) Parts of the web page response 228 may be the same as in any conventional served web page. For example, the web page response 228 may include main content 216, which may be copied or otherwise derived from the main content 216 stored at the server 212.

The web page response 228 also includes, however, an advertising pointer 230 which includes information that the web browser 206 may subsequently use to request advertising content associated with the advertising definition 218 from the advertising proxy server 226. For example, the web page response 228 may include the GUID 224, which was generated by the web server 212 and included within the advertising information message 220.

The web server 212 may transmit the advertising information message 220 and the web page response 228 at the same or similar times to each other. In fact, there need not be any particular temporal relationship between the transmission of the advertising information message 220 and the transmission of the web page response 228. The web server 212 need not wait for a response from the ad proxy server 226 before transmitting the web page response 228. In fact, as described below, the ad proxy server 226 may not transmit any response to the web server 212.

The web browser 206 receives the web page response 228. The web browser 206 may immediately render the main content 216 in a display 230 of the computing device 204 to produce rendered main content 232. In other words, the web browser 206 need not wait to receive advertising content before rendering the main content 216. The web server 212 may insert placeholders into the hypertext markup language (HTML) transmitted to the web browser 206 for the advertising content which has yet to be transmitted. Such placeholders may contain the GUID 224 received in the web page response 228. Such placeholders may, for example, be implemented as HTML image (<IMG>) tags which point to the advertising proxy server 226, wrapped in a clickable link back to the advertising proxy server, and referencing the GUID 224.

The web browser 206 transmits an advertisement request 236 to the advertising proxy server 226 to request advertising content. The advertising request 236 includes information identifying the advertising content being requested, such as the GUID 224 received in the web page response 228, and an indication of whether the request is an image request or a link request so that the correct action may be taken by the advertising proxy server 226 in response to the request. Such a request may be transmitted, for example, as a request for an image using the mechanisms normally used in connection with the HTML image (<IMG>) tag. Because the GUID 224 is embedded within the HTML image element, the GUID 224 is transmitted to the advertising proxy server 226 as part of this request.

Recall that the advertising proxy server 226 receives the advertising information message 220 from the web server 212. In response to receiving the advertising information message 220, the advertising proxy server 226 sends an advertisement request 238 to an advertising server 240. The advertisement request 238 includes information, derived from the advertising information message 220, sufficient to identify the advertising content being requested. The advertisement request 238 may be of a kind that is conventionally transmitted to third-party advertising servers. In fact, the advertising server 240 may be a conventional third-party advertising server, of the kind that also serves advertisements directly to web servers and web browsers without the use of the advertising proxy server 226.

In response to the request 238, the advertising server 240 transmits an advertisement response 242, containing advertising content 244, to the advertising proxy server 226. The advertising proxy server 226 transmits an advertisement response 246, derived from the advertisement response 242, to the web browser 206. The advertisement response 246 transmitted by the advertising proxy server 226 to the web browser 206 may, for example, simply be a copy of the advertisement response 242 received by the advertising proxy server 226 from the advertising server 240. Alternatively, for example, the advertising proxy server 226 may render a text advertisement into an image and then include the resulting image in the advertisement response 246. The rendered image may be sized according to the screen size of the computing device 204, as determined by looking up the user's user-agent in a device database.

The actions performed by the advertising proxy server 226 as described above may be performed while the web browser 206 receives the web page response 228 and renders the main content 216 of the web page 214. The advertising proxy server 226 need not wait for the request 236 from the web browser 206 before requesting the advertising content 244 from the advertising server 240, because the web server 212 has already provided the advertising proxy server 226 with all of the information it needs to request the advertising content 244 from the advertising server 240. As a result, the advertising proxy server 226 may request and receive the advertising content 244 even before the web browser 206 has sent the advertising request 236 to the advertising proxy server 226, in which case the advertising proxy server 226 may store the received advertising content 244, in anticipation of receipt of the advertising request from the web browser 206. Then, when the advertising proxy server 226 receives the advertisement request 236 from the web browser 206, the advertising proxy server 226 may immediately transmit the stored advertising content 244 to the web browser 206. If, alternatively, the advertising proxy server 226 has not yet received the advertising content 244 when it receives the advertising request 236 from the web browser 206, the advertising proxy server 226 may wait until it receives the advertisement response 242 from the advertising server 240 before transmitting the advertising content 244 to the web browser 206.

When the web browser 206 receives the advertising response 246, the web browser 206 extracts the advertising content 244 from the response 246 and renders the advertising content 244 within the display 230 as rendered advertising content 234. The result is that entire web page 214, including both the main content 216 and advertising content 244 have been rendered within the display 230 as main content 232 and advertising content 234, respectively.

The rendered advertising content 234 may be displayed as a linked (e.g., clickable) advertisement. If the user 202 subsequently clicks on the rendered advertising content 234, the web browser 206 may transmit a request (not shown) including the GUID 224 to the advertising proxy server 226, which uses the GUID 224 to look up the landing page for the advertising content 234, and then instructs the web browser 206 to perform a redirect to the landing page. The result is that the web browser 206 displays the landing page of the advertisement in response to the user 202 clicking on the rendered advertising content 234.

Embodiments of the present invention have a variety of advantages, some of which have already been described. For example, embodiments of the present invention enable even computing devices, such as mobile devices, lacking in significant computing resources and lacking web browsers with the ability to execute JavaScript code, to quickly display the main content of a web page without needing to wait for the advertising content of the web page to be retrieved. The main content may be displayed as soon as it is received from the web server, and the advertising content may be displayed later, as soon as it is received from the advertising server, all without requiring the computing device to execute JavaScript or other non-HTML code.

The web page request 208 and the advertising request 236 may be processed in parallel. Therefore, the web browser 206 may display whichever of the main content 216 and the advertising content 244 is received first. As a result, the web browser 206 is not limited to displaying the main content 216 first, followed by the advertising content 244. As a result, the web browser 206 may make both requests 208 and 236 in parallel with each other and display the main content 216 and the advertising content 214 as soon as they are received by the web browser 206, thereby minimizing delay in displaying content to the user 202.

Similarly, if the web page 214 includes multiple advertisements, rather than only the single advertisement shown in FIG. 2, the advertising proxy server 226 may make multiple advertising requests, potentially to multiple different advertising servers (not shown). The advertising proxy server 226 may process such requests in parallel to each other, and return the corresponding advertisements back to the web browser as soon as each of them is received. As a result, the slowdown of one advertising server need not delay the display of other advertisements, or of the main web page content 216, to the user 202.

Various details of embodiments of the present invention may be implemented in a variety of ways. For example, if the advertising server 240 fails to provide a response to the advertisement request 238, or fails to provide a response within a predetermined timeout period, the advertising proxy server 226 may transmit an advertisement response 236 to the web browser 206 containing a 1×1 (effectively invisible) pixel image.

If the advertising content 244 returned by the advertising server 240 is a text advertisement, the advertising proxy server 226 may convert the advertising content 244 into an image and return the image to the web browser 206 in the advertising response 246.

The advertising proxy server 226 may maintain a database which maps web site identifiers to the advertising servers to use to serve advertisement for those web sites. When the advertising proxy server 226 receives the advertising information message 220 from the web server 212, the advertising proxy server 226 may look up the web server 212 in the database to select the advertising server to which the advertisement request 238 should be sent. Multiple advertising servers may be associated with a single web site in the database, which may assign priorities to the advertising servers. In this case, the advertising proxy server 226 may try the advertising servers associated with a particular web site in the sequence specified by the database, in order to achieve higher fill rates. If the first advertising server in the sequence fails to provide a response, the advertising proxy server may then try the next advertising server in the list, and so on.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A method comprising:
at a web content server:
inserting a placeholder into a web page served to a web browser;
at the web browser:
rendering content from the web page;
requesting advertising content from an advertising proxy server using the placeholder; and
at the advertising proxy server:
requesting the advertising content from an advertising server;
receiving the advertising content from the advertising server; and
serving the advertising content to the web browser.

2. The method of claim 1, further comprising a step of, at the advertising proxy server, storing the advertising content from the advertising server in anticipation of a forthcoming request from the web browser using a globally unique identifier (GUID) generated by the web server, which identifies the web page request in a way that distinguishes it from all other web page requests.

3. The method of claim 1, further comprising a step of rendering the advertising content within the web page, at the web browser.

4. The method of claim 3, wherein the rendering of the content from the web page is independent of the rendering of the advertising content.

5. The method of claim 1, wherein the placeholder includes information pertaining to a globally unique identifier (GUID).

6. The method of claim 1, wherein the placeholder includes a hypertext markup language (HTML) image tag.

7. The method of claim 1, wherein the content from the web page includes at least one advertisement definition.

8. The method of claim 1, wherein the advertising proxy server is configured to wait for a response from the advertising server for a predetermined timeout period, and transmit an effectively invisible image to the web browser if the timeout period is exceeded.

9. The method of claim 1, wherein the advertising proxy server is configured to serve advertising content to a plurality of individual web browsers.

10. The method of claim 1, wherein the advertising proxy server is configured to serve advertising content on behalf of a plurality of individual advertising servers.

11. The method of claim 10, wherein the advertising proxy server is configured to maintain a database mapping web site identifiers to the individual advertising servers.

12. A computing apparatus, comprising:
a display;
an input device configured to receive user input; and
a controller operatively coupled to the display and the input device, the controller being configured to operate a web browser on the display in accordance with user input from the input device, the controller configuring the web browser to:
render content from a web page being served by a web content server, the web page having a placeholder inserted therein;
generate a first request for advertising content from an advertising proxy server based on the placeholder, the first request invoking a second request for advertising content from an advertising server; and
receive the advertising content.

13. The computing apparatus of claim 12, wherein the controller further configures the web browser to render the advertising content within the web page.

14. The computing apparatus of claim 13, wherein the controller configures the web browser to render the content from the web page independently of the advertising content.

15. The computing apparatus of claim 12, wherein the placeholder includes information pertaining to a globally unique identifier (GUID).

16. The computing apparatus of claim 12, wherein the placeholder includes a hypertext markup language (HTML) image tag.

17. The computing apparatus of claim 12, wherein the content from the web page includes at least one advertisement definition.

18. The computing apparatus of claim 17, wherein the advertisement definition includes only features of an advertisement to be rendered within the web page.

19. The computing apparatus of claim 12, wherein the controller configures the web browser to execute only HTML code.

20. A method comprising:
at a web content server:
inserting an HTML image tag into a web page served to a web browser;
at the web browser:
rendering content from the web page;
requesting advertising content from an advertising proxy server using the HTML image tag;
at the advertising proxy server:
requesting the advertising content from an advertising server;
receiving the advertising content from the advertising server;
serving the advertising content to the web browser; and
at the web browser:
rendering the advertising content within the web page.
